(19) United States
(12) Patent Application Publication
(10) Pub. No.: US 2010/0178928 A1
(43) Pub. Date: Jul. 15, 2010

(54) Capacity protection/reservation based on location of end user mobile device

(75) Inventor: Gerard P. O'Reilly, Manalapan, NJ (US)

Correspondence Address: HARNESS, DICKEY & PIERCE, P.L.C., P.O. BOX 8910, RESTON, VA, 20195, US

(73) Assignee: LGS Innovations LLC

(21) Appl. No.: 12/318,898

(22) Filed: Jan. 12, 2009

(51) Int. Cl. H04W 72/00; H04W 24/00

(52) U.S. Cl. 455/452.2; 455/456.1

(57) ABSTRACT

With the advent of communication devices including Global Positioning capability, for example, mobile communications networks and GPS may be coordinated to determine where a user is located and to reserve capacity in the mobile communications network should the user need to make a call. Example Embodiments include the GPS being used to locate a user and compute a movement vector of that user in order to predict future locations, e.g., a next cell where the user will be located, at which the communications network may reserve appropriate capacity for that user. This service may be used by emergency service workers or government officials who need to communicate in times of emergency or when network overloads occur. Premium service callers who would like to ensure that their calls get through may also use this service for an added fee.

### BACKGROUND OF THE INVENTION

Global Positioning Systems (GPS) and the primary telecommunication networks such as Public Switched Telephone Network (PSTN), which includes both landline and wireless networks, etc., operate independently of one another on the equipment level. When a user is unable to make an important call on their wireless device because of insufficient capacity in their mobile communications system, they will have to wait until capacity is available to make their call. Currently, there is no automatic way of making capacity available, e.g., on demand, to those that need it other than supplying special communications networks for these user's special needs, which may be an expensive and cost prohibitive proposition.

FIG. 1 illustrates an example of conventional networks. On side A, as part of a wireless network, there are various mobile devices 100, including a mobile phone 100′, a personal digital assistant (PDA) or smartphone 100″, and a laptop computer 100, which intend to communicate with landline 260′ or mobile user 260 (through an air interface, not shown) as shown on Side B. A call normally travels over the air interface capacity 210 to a base station 220/221, backhaul capacity 230 to the radio network controller 240, the serving Mobile Switching Center 250, the PSTN 300 and on to the terminating landline 260′ or mobile device 260 on Side B. The term “call”, covers any desired communication between: users and other users or endpoints, including voice, data, video, and any combinations of these. If there is network congestion, a call may be blocked because of insufficient resources for the side A users to complete the communication. Therefore, the side A users would have to try again later and take their chances on the network having sufficient capacity for completing a call at that time. Thus, during times of congestion, the likelihood of completing their desired communication may be low.

This lack of guaranteed resources may result in unacceptable conditions for different types of users, for example, emergency workers (police, first responders, EMS, firefighters, etc.) and premium service users. Currently these types of users may get service through other means, for example, Government Emergency Telecommunications Service (GETS) and/or Wireless Priority Service (WPS) where special codes are assigned for specific callers/users in order to move them to the front of the service queue. However, these specialized service networks do not allow a user to reserve capacity in advance as a function of the location of the user.

### SUMMARY OF THE INVENTION

With the advent of communication devices including Global Positioning capability, for example, mobile communications networks and GPS may be coordinated to determine the location of a user. Example embodiments make use of this location information in reserving capacity in the mobile communications network should the user need to make a call. Example Embodiments include GPS being used to locate a user and compute a movement vector of that user in order to predict future locations, e.g., a next cell where the user will be located, and the communications network may reserve appropriate capacity for that user. This service may be used by emergency service workers or government officials who need to communicate in times of emergency or when network overloads occur. Premium service callers who would like to ensure that their calls get through may also use this service, for example, for an added fee.

Example embodiments include methods of reserving network bandwidth and preventing dropped calls within telecommunications networks, including wireless telecommunications networks having GPS capabilities. Example methods include receiving location data for a user at a network node and determining the nearest base station to a future path of the user. Example methods also include signaling the determined nearest base station to reserve bandwidth for the user.

Example embodiments use GPS user location data and determine a movement vector for the user, which predicts the future path of the user. The movement vector may be determined based on at least a recent location history of the user and a base station map.

Example embodiments further include assigning the reserved bandwidth to the user if the user moves within range of the nearest future base station and repeating the receiving, determining, and signaling steps as the user moves.

Example embodiments also include tracking movement of a user to determine a movement vector for the user and predicting future movement of the user based on at least the movement vector. Example embodiment methods further include selecting at least one next network node based on the predicted future movement and reserving bandwidth for the user at that one selected network node. Bandwidth could also be reserved at additional selected network nodes along the targeted path for the user. Example embodiments also include providing the method as a user option and receiving the selection of the user option by the user. The selecting and reserving steps may include a plurality of network nodes and the reserved bandwidth may be released at any of the selected network nodes.

### BRIEF DESCRIPTION OF THE DRAWINGS

Example embodiments will be more clearly understood from the following detailed description taken in conjunction with the accompanying drawings. FIGS. 1-4 represent non-limiting, example embodiments as described herein.

FIG. 1 illustrates an example of conventional networks;

FIG. 2 illustrates a wireless network including GPS satellites according to an example embodiment;

FIG. 3 is a flow chart illustrating a method according to an example embodiment; and

FIG. 4 is a signaling diagram illustrating example communications between GPS satellite, a user, a base station, a radio network controller, and an Automatic Management System (AMS).

### DETAILED DESCRIPTION OF THE EMBODIMENTS

Various example embodiments will now be described more fully with reference to the accompanying drawings in which some example embodiments are illustrated.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Spatially relative terms, e.g., “beneath,” “below,” “lower,” “above,” “upper” and the like, may be used herein for ease of description to describe one element or a relationship between a feature and another element or feature as illustrated in the figures. It will be understood that the spatially relative terms are intended to encompass different orientations of the device in use or operation in addition to the orientation depicted in the Figures. For example, if the device in the figures is turned over, elements described as “below” or “beneath” other elements or features would then be oriented “above” the other elements or features. Thus, for example, the term “below” can encompass both an orientation which is above as well as below. The device may be otherwise oriented (rotated 90 degrees or viewed or referenced at other orientations) and the spatially relative descriptors used herein should be interpreted accordingly.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the present invention and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities.

Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

As used below the terms base station, base transceiver station (BTS) and NodeB are synonymous and may be used interchangeably to describe equipment that provides data connectivity between a wireless network and one or more UEs. Additionally where used below, the terms user, user equipment (UE), subscriber, mobile station, and remote station are synonymous and may be used interchangeably to describe a remote user of wireless resources in a wireless communication network.

Example embodiments include methods for telecommunications users to increase the success rate of communication completions during: a) unexpected emergencies, b) overload, non-emergency situations, and c) normal operations where channel capacity might be fully utilized thereby preventing new communications from getting through. The reservation capability and/or service is automatic and does not rely on any user actions. For purposes of ease, the service will be referred to as a reservation service, however, one of ordinary skill in the art understands that the name of the service may be changed.

Example embodiments use a signaling network and databases to reserve capacity for potential communications (e.g., telephone calls, messages, emails, alerts, etc.) so that they will complete in: a) cases of network congestion and/or partial failure, b) overload situations, c) normal situations where the user does not want to be subject to normal random blocking conditions, etc. In these cases when a communication is attempted, the reserve capacity may be activated and used for completion. GPS and mobile telecommunications networks work together through the use of signaling, for example, database queries, to make available, in advance, network capacity for communication completion. When a communication from a user is attempted, the communication automatically uses the reserved capacity on the network to complete the communication.

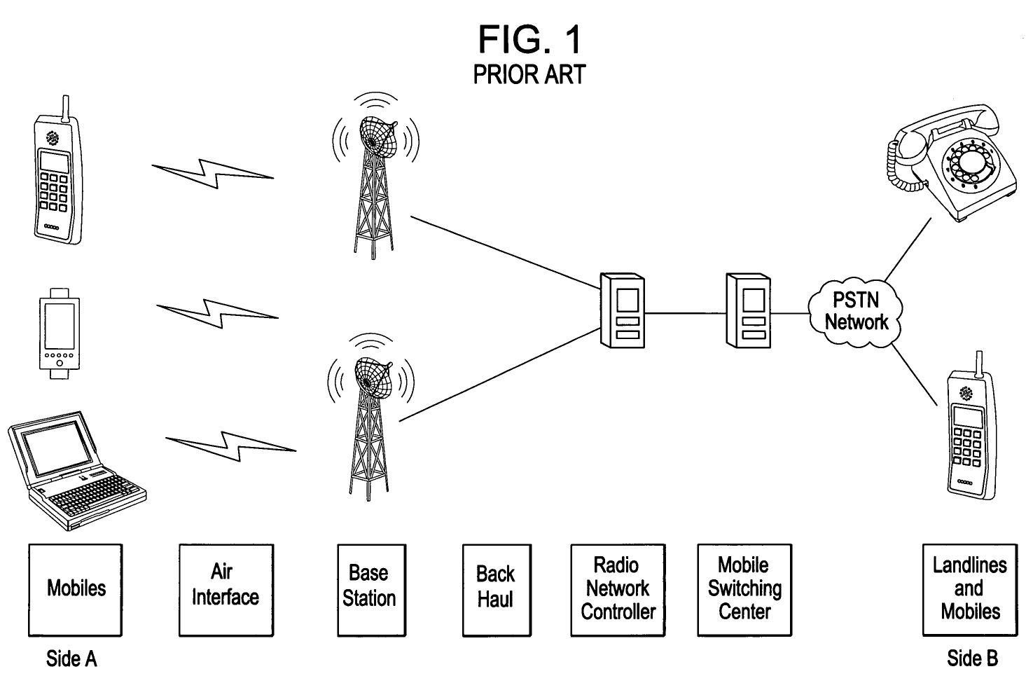

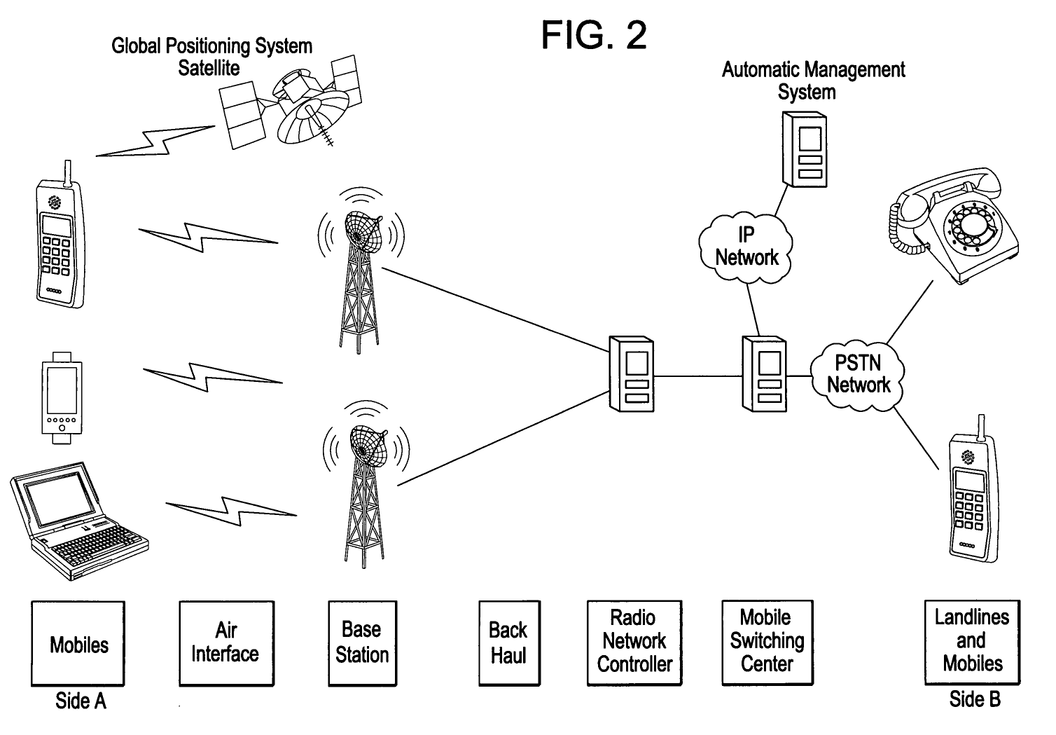

FIG. 2 is the same as FIG. 1, but includes the addition of GPS satellites 280, GPS capable mobile devices 200-200″, and automatic management system (AMS) 270. In FIG. 2, the GPS capable mobile devices 200-200″ are able to determine their position on the earth at any given instant in time. The AMS 270 tracks network capacity for users and reserves network capacity and/or bandwidth at various base stations 220 when the reservation service is enabled and/or activated. The AMS 270 may be software located/stored at a network node, e.g., a server, a switch, etc. or it could be a separate server with the requisite software that is hardwired at various other nodes, such as, the radio network controller 240, the mobile switching center 250, or other nodes accessible from IP Network 290. The reservation service may be offered by a service provider as an added user option and/or included in a service package. A user may select to activate the reservation service, the service provider receiving such a selection from the user. If the reservation service is active, a user has priority service and/or may request reserved bandwidth. The reservation service may be used wherever a user is currently located or will be located during the user's travel from place to place. The reservation service can be activated either when the user is not within an active session or call or when the user is currently within an active session or call.

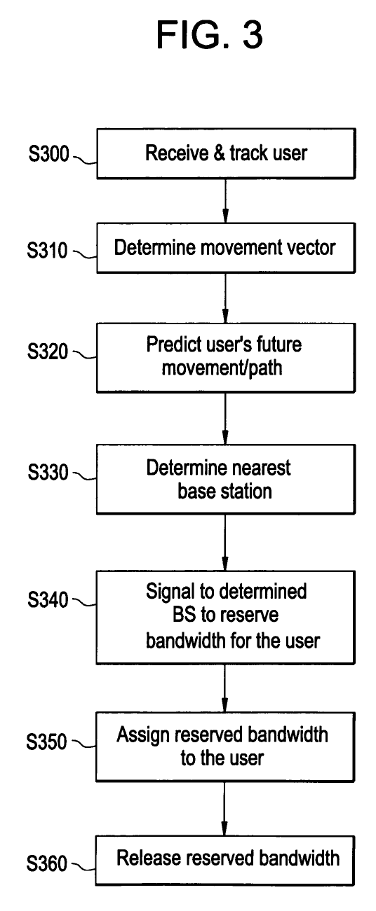

As illustrated in FIGS. 2, 3, and 4, in situations where network calls might not otherwise be completed because of insufficient capacity, a user, e.g., 200′ has capacity reserved in advance for their use. For purposes of brevity, example embodiments will reference mobile device 200′, however it is understood by one of ordinary skill in the art that any mobile device, e.g., 200, 200′, 200″, etc., may be used. The reservation service determines possible future locations for the user 200′ based on, for example, the user's current location, the direction the user is traveling in, the user's speed, user information known to the service provider (e.g., a map of base stations, user location history, etc.), existing network conditions, etc. For example, GPS 280 and AMS 270 may be used to locate user 200′ and determine a movement vector for user 200′ in order to predict the user's future locations, e.g., next cell or cells.

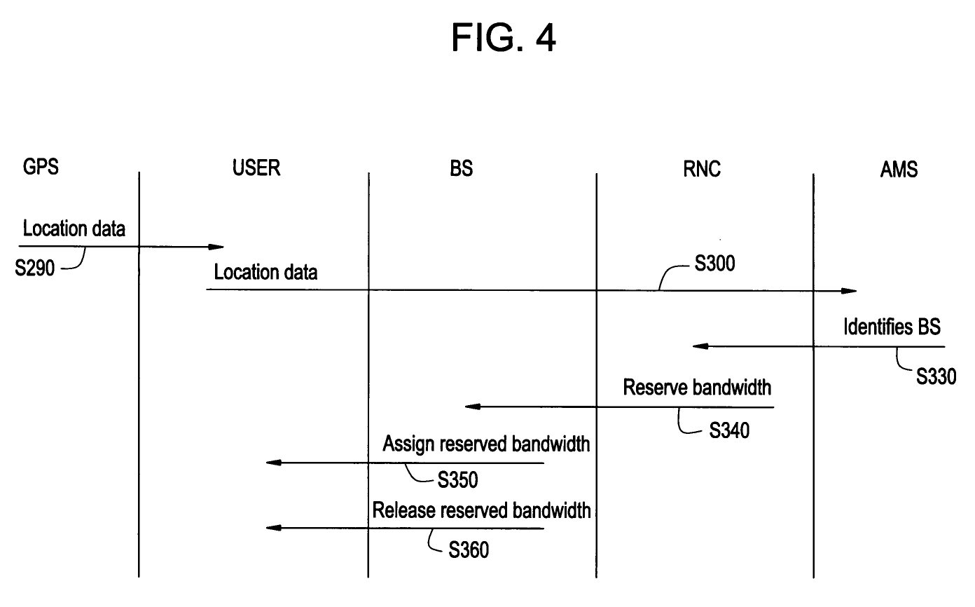

In example embodiments, mobile devices 200-200″ may continuously receive location information from GPS satellites 280 through signaling S290, as shown in FIG. 4. Mobile device 200′ may relay the location information to AMS 270 over IP network 290 in step S300 by various known methods, for example, signaling over the air interface, signaling system 7, control messages over the IP network, etc. The AMS 270 may determine a movement vector of the mobile device 200′ in step S310, which indicates the future movement and location of the mobile device 200′, and determine the location of base stations in the vicinity of the user's predicted future location in step S320. The movement vector may be determined using a variety of known methods, for example, a least squares fit of past points used to predict future points, or if traveling at higher speeds (e.g., the user is on a highway), future points may be expected to continue on that highway in the same movement direction. The AMS 270 then signals to the nearest base station or stations that may potentially serve user 200′ to reserve bandwidth for user 200′ in step S330 by, for example, through the internal communications network of the service provider. For example, if user 200′ was originally within the area covered by base station 220 but moves towards base station 221, then AMS 270 would determine that base station 221 is the nearest base station in the future path of user 200′ and signal to base station 221 and/or RNC 240 to reserve bandwidth for user 200′. RNC 240 and Base station 221 would then reserve and assign available capacity (or the next available capacity) to user 200′ in step S340.

Once user 200′ uses the reserved capacity or, for example, a time interval has elapsed, the reserved bandwidth is released by base station 221 and RNC 240 in step S350, etc. The time interval may be determined and/or set by the service provider based on, e.g., a service agreement, network conditions, etc. Alternatively, in view of the user's 200′ location, AMS 270 may allocate capacity along the user's 200′ traveling path in advance of user 200′ and free the allocated capacity after user 200′ moves beyond anticipated locations. As discussed above, AMS 270 may anticipate where user 200′ will be located at a future instant and therefore, AMS 270 knows when user 200′ passes from one base station boundary to another and/or from one Mobile Switching Center area to another. The reservation service may also be extended to multiple users.

As discussed above, the reservation service may be an additional user option or included in a package. When a base station detects a user within its serving area, the base station may query a database about the user's capabilities. For example, a base station, radio network controller or MSC may determine the service/feature status of the user by querying various components of a network (e.g., a user profile database, a user subscription database, a home location register (HLR), a visitor location register (VLR), etc.) using an identifier associated with the user (e.g., Mobile Identification Number (MIN), International Mobile Subscriber Identity (IMSI), etc.).

After the feature status of the originating user is determined, the determining network node communicates the feature status to AMS 270, which determines if the user will be using reserved capacity already allocated or not. If not, then communications proceed in the normal fashion, e.g., searching for available capacity through the Radio Network Controller and Mobile Switching Center. If no capacity is available, the communication is blocked. Alternatively, if the feature is activated and capacity reserved, then a communication request to use the reserved capacity is forwarded to the Mobile Switching Center, Radio Network Controller, and Base Station, and the communications use the reserved capacity.

The invention being thus described, it will be obvious that the same may be varied in many ways. Such variations are not to be regarded as a departure from the invention, and all such modifications are intended to be included within the scope of the invention.

I claim:

1. A method of reserving network bandwidth, comprising:
receiving location data for a user at a network node;
determining the nearest base station to a predicted future path of the user; and
signaling the determined nearest base station to reserve bandwidth for the user.

2. The method of claim 1, wherein the user location data includes GPS data.

3. The method of claim 1, wherein the determining step includes:
determining a movement vector for the user, wherein the movement vector indicates the future path of the user.

4. The method of claim 3, wherein the movement vector is determined based on at least, a recent location history of the user and a map of base stations.

5. The method of claim 1, further including:
assigning the reserved bandwidth to the user if the user moves within range of the determined nearest base station.

6. The method of claim 5, further including:
repeating the receiving, determining, and signaling steps as the user moves.

7. The method of claim 6, wherein the user location data is GPS data.

8. The method of claim 1, further including:
providing the method as a user option.

9. The method of claim 8, further including:
receiving the selection of the user option by the user.

10. A method of preventing dropped calls, comprising:
tracking movement of a user to determine a movement vector for the user;
indicating future movement of the user based on at least the movement vector;
selecting at least one next network node based on the indicated future movement; and
reserving bandwidth for the user at the at least one selected network node.

11. The method of claim 10, further including:
assigning to the user the reserved bandwidth if the user moves within range of the selected network node.

12. The method of claim 10, wherein the tracking uses GPS data.

13. The method of claim 10, wherein the indicating is based on the movement vector, a recent location history for the user and a map of base stations.

14. The method of claim 11, further including:
repeating the tracking, indicating, selecting, reserving, and assigning steps as the user moves.

15. The method of claim 14, wherein the tracking uses GPS data.

16. The method of claim 10, wherein
the selecting includes selecting a plurality of next network nodes based on the indicated future movement; and
the reserving step reserves bandwidth for the user at the plurality of selected network nodes.

17. The method of claim 10, further including:
providing the method as a user option.

18. The method of claim 17, further including:
receiving the selection of the user option by the user.

19. The method of claim 10, further including:
releasing the reserved bandwidth at the selected network node.
